(19) United States
(12) Patent Application Publication
(10) Pub. No.: US 2025/0388163 A1
(43) Pub. Date: Dec. 25, 2025

(54) EXPANDABLE CUP HOLDER

(71) Applicant: Shenzhen Glamortech Industrial Co., Ltd., Shenzhen (CN)

(72) Inventor: PENGBO MU, Huizhou (CN)

(21) Appl. No.: 19/312,305

(22) Filed: Aug. 28, 2025

(30) Foreign Application Priority Data
Jun. 23, 2025 (CN) 202510845264.5

(51) Int. Cl. B60N 3/10

(52) U.S. Cl. CPC B60N 3/106

(57) ABSTRACT

Provided is an expandable cup holder, including a cup holder body and a blade slidably connected to the cup holder body. The cup holder body includes an upper disc, an elastic potential energy storage component, and a lower disc that are successively disposed. The upper disc is fixedly connected to the lower disc. The elastic potential energy storage component includes a first elastic member and a second elastic member. Two ends of the first elastic member are respectively fixedly connected to the upper disc and the elastic potential energy storage component, and the first elastic member is configured to store elastic potential energy. Two ends of the second elastic member are respectively fixedly connected to the upper disc and the elastic potential energy storage component, and the second elastic member is configured to prevent the elastic potential energy storage component from automatically releasing the elastic potential energy.

### TECHNICAL FIELD

The present disclosure relates to the field of vehicle technologies, and specifically, to an expandable cup holder.

### BACKGROUND

In people's life, to meet a travel requirement, people usually carry various water cups. In addition, as travel population increases, to meet requirements of convenience and comfort, cup slots for placing the water cups are added in different life application scenarios.

However, vehicle-mounted cup slots are usually of fixed dimensions. Moreover, different people use different sizes and shapes of water cups. As a result, it is possible that the water cup is too large in size to be placed in the cup slot, or after the water cup with a relatively small size is put in the cup slot, there is a gap between the water cup and the cup slot, and the water cup collides and breaks.

### SUMMARY

In view of this, embodiments of the present disclosure provide an expandable cup holder aiming at the defect that a cup slot in an existing automobile is unadjustable. When the size of a water cup does not fit with the cup slot in the automobile and the size of the cup slot in the automobile cannot fix the water cup, the expandable cup holder may be mounted, and the size may be adjusted freely to adapt the water cup.

To achieve the above objective, the present disclosure has the following technical solutions.

An expandable cup holder includes a cup holder body and a blade slidably connected to the cup holder body.

The cup holder body includes an upper disc, an elastic potential energy storage component, and a lower disc that are successively disposed.

The elastic potential energy storage component includes a first elastic member and a second elastic member. The elastic potential energy storage component is elastically connected to the upper disc by using the first elastic member. The first elastic member is configured to store elastic potential energy. The elastic potential energy storage component is elastically connected to the upper disc by using the second elastic member. The second elastic member is configured to prevent the elastic potential energy storage component from automatically releasing the elastic potential energy.

The upper disc is fixedly connected to the lower disc.

Further, the elastic potential energy storage assembly includes at least one first elastic member. The upper disc is provided with at least one first upper disc fixed column. The elastic potential energy storage component includes a middle disc. The middle disc is provided with at least one middle disc fixed column. Two ends of the first elastic member are respectively fixedly connected to the first upper disc fixed column and the middle disc fixed column.

Further, the elastic potential energy storage component includes a trigger switch. The trigger switch is provided with a support column. The upper disc is provided with a second upper disc fixed column. Two ends of the second elastic member are respectively fixedly connected to the support column and the second upper disc fixed column.

Further, the elastic potential energy storage component includes a brake member. The brake member is provided with a slotted hole. The upper disc is provided with an upper disc shaft column. The brake member is connected to the upper disc shaft column by using the slotted hole.

Further, the brake member is provided with a columnar body. The trigger switch is provided with a guide rail. The brake member slides in the guide rail by using the columnar body to be slidably connected to the trigger switch.

Further, the brake member is provided with a brake member toothed structure. The middle disc is provided with a first middle disc toothed structure. The brake member toothed structure is in meshed connection with the first middle disc toothed structure.

Further, an outer edge of the trigger switch is provided with at least one bulge structure.

Further, the blade is provided with a sliding chute. The upper disc is provided with an upper disc sliding rail. The blade is slidably connected to the upper disc sliding rail by using the sliding chute.

Further, the cup holder body further includes a gear. The upper disc is provided with a gear fixed column. The gear is rotatably connected to the gear fixed column.

Further, one surface that is of the blade and that deviates from the sliding chute is provided with a blade toothed structure. The blade includes a blade middle slot. The blade middle slot passes through the gear fixed column, so that the blade toothed structure is meshed with the gear.

Further, the middle disc is provided with a second middle disc toothed structure. The second middle disc toothed structure is meshed with the gear.

The embodiments of the present disclosure have the following beneficial effects.

According to an expandable cup holder provided in the present disclosure, the blade encloses clamping space of the expandable cup holder. An elastic tongue is mounted at a middle part of the blade, and a toothed structure disposed at the bottom of the blade is connected to the gear in the cup holder body to be linked and telescoped, so that the blade moves toward or away from a center.

The brake member is disposed between the upper disc and the middle disc. The second elastic member between the upper disc and the trigger switch abuts against the trigger switch. The guide rail on the trigger switch presses the brake member to be in meshed connection with the middle disc. The gear is disposed in the upper disc in combination with the toothed structure on the blade, so as to control expansion and contraction of the blade. The first elastic member is disposed between the upper disc and the middle disc, so as to achieve a purpose of automatic opening.

Firstly, the upper disc in the cup holder body has the sliding rail, the blade is mounted on the sliding rail, and the toothed structure on the blade is connected to the gear mounted on the upper disc, so that the blades are linked and telescoped synchronously and simultaneously move toward or away from the center.

Secondly, the three identical second toothed structures included in the middle disc are respectively arranged at an angle of 120 degrees, and are connected to the gear mounted on the upper disc, so as to ensure that the three gears move simultaneously. The first elastic member (for example, a spring) is disposed between the upper disc and the middle disc. The two ends are respectively connected to the fixed columns on the upper disc and the middle disc, so as to play a role of simultaneous compression and release. Compression of the blade causes rotation of the gear. The blade moves toward the center to narrow the clamping space. In addition, the first elastic member is compressed to achieve a purpose of energy storage of the first elastic member.

Thirdly, the second elastic member is disposed between a brake switch and the upper disc, so that the brake member toothed structure on the brake member is combined with the first middle disc toothed structure, so as to control the compression of the blade only to reduce the clamping space of the blade when the middle disc is combined with the brake member, thereby tightening the blade and clamping the water cup. The blade cannot be expanded by extending and releasing energy from the first elastic member. The purpose that an opening and closing degree of the blade is fixed so as to facilitate placement of the water cup cannot be achieved.

Fourthly, the trigger switch is located between the middle disc and the lower disc, and the switch is turned on by rotating clockwise on an outer edge of the cup holder body, so that the brake member rotates by using the guide rail to disengage from the first middle disc toothed structure. It is unable to reach the effect of preventing the first elastic member from extending and releasing energy, the first elastic member is extended, and stored elastic potential energy is released, so that the middle disc rotates counterclockwise under the action of the first elastic member, so as to drive the gear to rotate, thereby expanding the blade, and releasing the outer edge of a cup wall, and achieve the purpose of automatically expanding the blade.

According to the expandable cup holder, the blade and the gear disposed in the cup holder body are linked and telescoped, and the gear rotates by compressing the blade. The first elastic member is compressed to store energy while the clamping volume of the blade is reduced, and the brake member toothed structure on the brake member is connected to the first middle disc toothed structure, so as to control to extend the first elastic member and release energy, thereby maintaining the expanded volume of the blade, and facilitating placement of different sizes of water cups. When a contact part of the trigger switch is shifted by a hand, the brake member is driven to rotate and disengage from the first middle disc toothed structure, the first elastic member releases energy and is extended to drive the gear to rotate, and the middle disc rotates clockwise. In addition, the blade automatically expands to release the clamped cup, thereby facilitating the cup to be taken out. Moreover, containers such as water cups are different in shapes, volumes, and sizes. The compressed blade drives the gear to reduce the clamping space of the blade, so that the clamping space of the blade fits with the cup, so as to fit different sizes of containers. The cup holder is high in degree of generality, convenient to use, high in clamping stability, independent of an automobile electric power system under the action of an internal mechanical transmission, few in operation steps, and simple in operation. Operation steps of a driver are reduced during driving, so that safety of driving is enhanced.

To make the above objectives, features and advantages of the present disclosure be more obviously understood, the following detailed description is set forth with particularity to the preferred embodiments in conjunction with the accompanying drawings.

### BRIEF DESCRIPTION OF THE DRAWINGS

To describe the technical solutions in embodiments of the present disclosure more clearly, the following briefly describes the accompanying drawings required for describing the embodiments. It should be understood that, the accompanying drawings in the following descriptions show merely some embodiments of the present disclosure, and thus should not to be regarded as limitation of the scope; and a person of ordinary skill in the art may derive other accompanying drawings from these accompanying drawings without creative efforts.

FIG. 1 is a structural exploded view of an expandable cup holder according to an embodiment of the present disclosure;

FIG. 2 is a schematic diagram of an integral structure of an expandable cup holder according to an embodiment of the present disclosure;

FIG. 3 is a schematic structural diagram of a trigger switch according to an embodiment of the present disclosure;

FIG. 4 is a schematic structural diagram of an upper disc according to an embodiment of the present disclosure;

FIG. 5 is a schematic structural diagram of a middle disc according to an embodiment of the present disclosure;

FIG. 6 is a schematic structural diagram of a brake member according to an embodiment of the present disclosure;

FIG. 7 is a schematic structural diagram of a lower disc according to an embodiment of the present disclosure;

FIG. 8 is a schematic structural diagram of a blade according to an embodiment of the present disclosure;

FIG. 9 is a structural bottom view of a blade according to an embodiment of the present disclosure;

FIG. 10 is a schematic structural diagram of a gear according to an embodiment of the present disclosure;

FIG. 11 is a schematic structural diagram of a first elastic member according to an embodiment of the present disclosure;

FIG. 12 is a schematic structural diagram of a clamping tongue according to an embodiment of the present disclosure; and

FIG. 13 is a schematic structural diagram of a second elastic member according to an embodiment of the present disclosure.

### REFERENCE SIGNS IN ACCOMPANYING DRAWINGS

1: trigger switch; 101: guide rail; 107: support column; 111: bulge structure;
2: upper disc; 202: upper disc mounting hole; 203: gear fixed column; 204: first upper disc fixed column; 205: upper disc sliding rail; 206: upper disc shaft column; 207: second upper disc fixed column;
3: middle disc; 302: middle disc mounting hole; 304: middle disc fixed column; 308: second middle disc toothed structure; 309: first middle disc toothed structure;
4: brake member; 401: columnar body; 406: slotted hole; 409: brake member toothed structure;
5: lower disc; 502: lower disc mounting column; 503: lower disc fixed part;
6: blade; 603: blade middle slot; 605: sliding chute; 608: blade toothed structure; 612: clamping slot;
7: gear; 703: gear mounting hole; 708: gear structure;
8: first elastic member;
9: clamping tongue; 912: clamping part; 913: elastic tongue;
10: second elastic member;
11: base.

### DETAILED DESCRIPTION OF THE EMBODIMENTS

To make the objectives, technical solutions, and advantages of the embodiments of the present disclosure clearer, the technical solutions in the embodiments of the present disclosure will be clearly and comprehensively described below with reference to the accompanying drawings in the embodiments of the present disclosure. Clearly, the described embodiments are merely some rather than all of the embodiments of the present disclosure. Generally, the described and illustrated components of the embodiments of the present disclosure in the accompanying drawings can be arranged and designed through various different configurations.

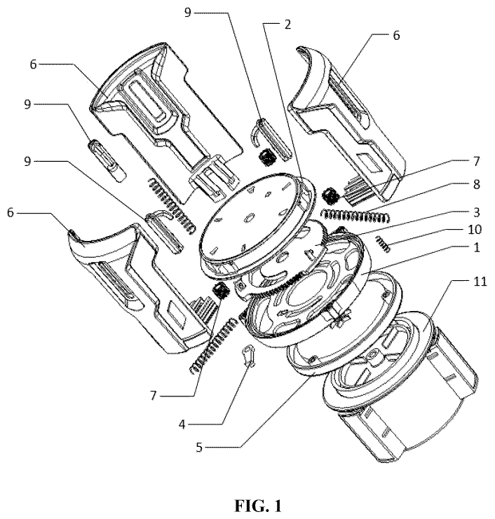

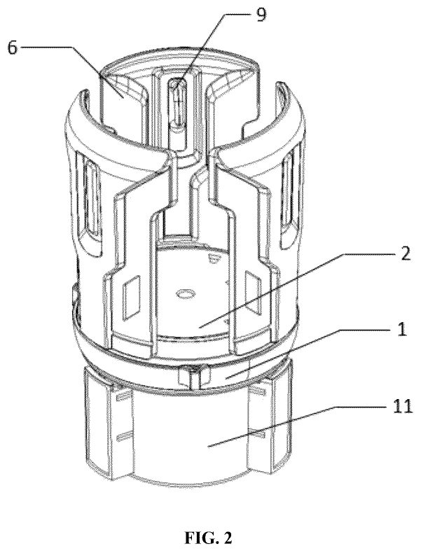

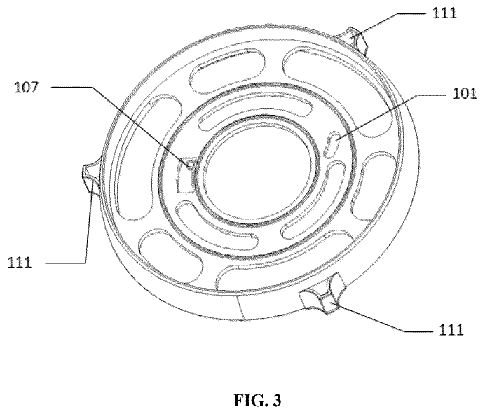

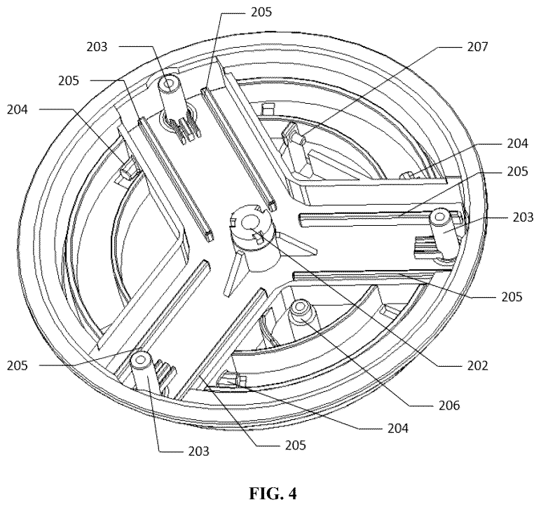

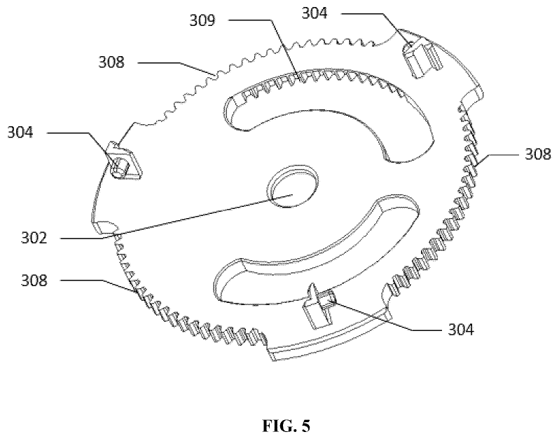

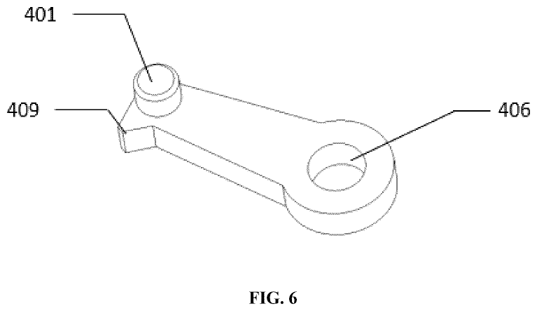

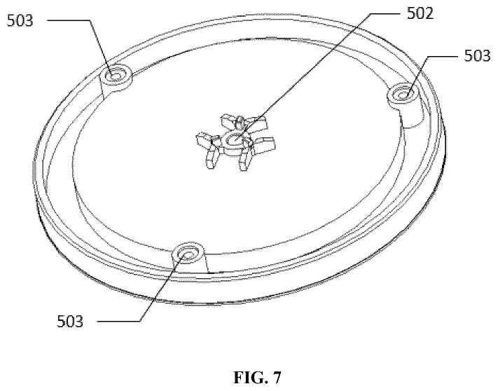

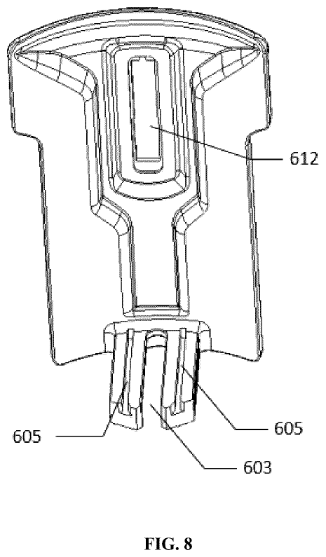

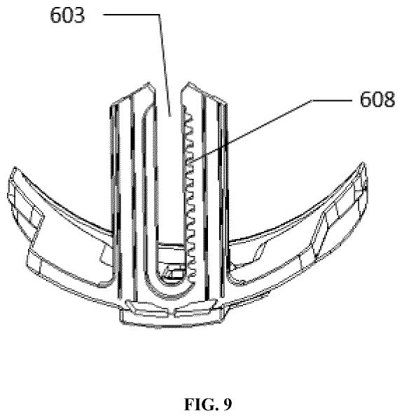

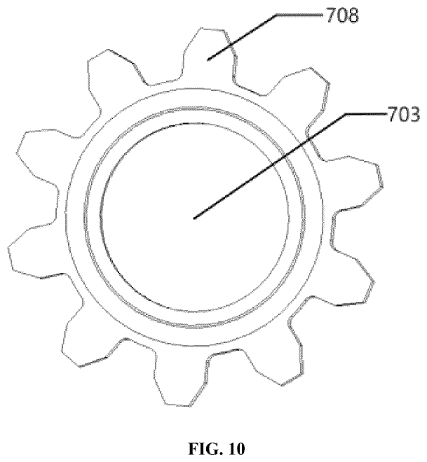

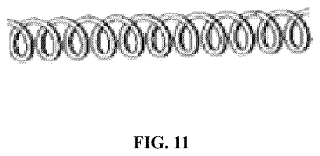

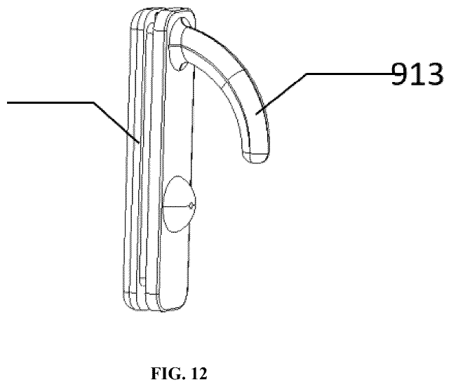

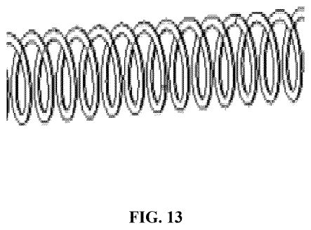

Referring to FIG. 1 to FIG. 13, the embodiments of the present disclosure provide an expandable cup holder, including a cup holder body and a blade 6 slidably connected to the cup holder body. The blade 6 is approximately L-shaped, where the cup holder body includes an upper disc 2, an elastic potential energy storage component and a lower disc 5 that are successively disposed. The elastic potential energy component includes a trigger switch 1, a middle disc 3, a brake member 4, a gear 7, a first elastic member 8, and a second elastic member 10. In addition, a base 11 may further be disposed on the expandable cup holder, and the base 11 may be fixedly connected to the lower disc 5. The base 11 is mainly mounted in circular cup slots in various application scenarios, for example, an automobile vehicle-mounted cup slot, and is integrated with the circular cup slot, thereby improving utilization rate of space, and further improving clamping stability and convenience.

An upper disc mounting hole 202 is disposed in a geometric center of the upper disc 2. Correspondingly, a middle disc mounting hole 302 is disposed in a geometric center of the middle disc 3. A trigger switch center hole is disposed in a geometric center of the trigger switch 1. A lower disc mounting column 502 with an internal thread is disposed in a geometric center of the lower disc 5. Screws may be used to sequentially pass through the upper disc mounting hole 202, the middle disc mounting hole 302, the trigger switch center hole, and the lower disc mounting column 502, so as to implement a fixed connection of the cup holder body.

The following describes in detail a connection and a movement manner between components of the expandable cup holder according to the embodiments of the present disclosure. Specifically, a clamping tongue 9 is disposed on the blade 6. A sliding chute 605 on the blade 6 is slidably mounted on an upper disc sliding rail 205. The gear 7 is rotatably mounted on a gear fixed column 203 by using a gear mounting hole 703. A blade middle slot 603 passes through the gear fixed column 203 on the upper disc 2, so that a blade toothed structure 608 at the bottom of the blade is connected to a gear structure 708. A second middle disc toothed structure 308 is meshed with the gear structure 708. Two ends of the first elastic member 8 are respectively fixedly connected to a first upper disc fixed column 204 and a middle disc fixed column 304. A slotted hole 406 in the brake member 4 is rotatably connected to an upper disc shaft column 206. the brake member 4 may rotate around the shaft column 206. A columnar body 401 on the brake member 4 may slide in a guide rail 101 on the trigger switch 1. In addition, two ends of the second elastic member 10 (for example, a spring) are respectively fixedly connected to a support column 107 on the trigger switch 1 and a second upper disc fixed column 207 on the upper disc 2. A brake member toothed structure 409 of the brake member 4 is connected to a first middle disc toothed structure 309 of the middle disc. In addition, the clamping tongue 9 is clamped into a clamping slot 612 at an upper end of the blade by using a clamping part 912, and the water cup is clamped by using the elastic tongue 913.

Further, a fixed through hole is disposed in the gear fixed column 203 of the upper disc 2. Correspondingly, an outer diameter of a middle disc outer edge avoidance part (not shown in the figure), that is, at a position that is of the middle disc 3 and that corresponds to the gear fixed column 203, is less than a distance between the gear fixed column 203 and a circle center of the upper disc, so as to avoid the gear fixed column 203. An avoidance hole is disposed in the trigger switch 1. A lower disc fixed part 503 with an internal thread is disposed on the lower disc, and screws may be used to sequentially pass through the fixed through hole, the middle disc outer edge avoidance part, the avoidance hole, and the lower disc fixed part 503, so as to further implement a fixed connection of the cup holder body.

In one of the embodiments, a user manually shifts a bulge structure 111 disposed on an outer edge of the trigger switch 1. The bulge mechanism 111 may increase resistance, which facilitates the user to preferably shift the trigger switch 1. The trigger switch 1 may rotate clockwise to drive the columnar body of the brake member 4 to slide in the guide rail 101 on the trigger switch 1, so that the brake member toothed structure 409 of the brake member 4 deviates from the first middle disc toothed structure 309. Therefore, the elastic potential energy storage component releases the released energy, and the first elastic member 8 can drive the middle disc 3 to rotate clockwise. The middle disc 3 drives the gear 7 to rotate by using the second middle disc toothed structure 308. The gear 7 drives the blade toothed structure 608 to move, so that the blade 6 moves in a direction deviating from the circle center of the upper disc 2, thereby enlarging the clamping space of the blade 6 and facilitating to take out the cup.

It may be understood that this is one of implementations of the trigger switch provided in the embodiments of the present disclosure. The trigger switch may further implement disengagement of the brake member from the middle disc by rotating, sliding, pressing, and the like. Details are not described herein again.

In one of embodiments, the user manually pushes one or more blades 6 to move toward the circle center of the upper disc 2. The blade 6 drives the gear 7. The gear structure 708 of the gear 7 drives the second middle disc toothed structure 308 of the middle disc 3 to move counterclockwise, thereby reducing the clamping space of the blade 6 to play a role in clamping the cup. When the middle disc 3 moves counterclockwise, the middle disc 3 may push the brake member 4 to rotate, which does not prevent the middle disc 3 from moving. When the middle disc 3 moves counterclockwise, the first elastic member 8 is compressed to play an energy storage role. When there is no external force, the second elastic member 10 is in a compressed or elongated state, which may push or pull the trigger switch 1 to rotate counterclockwise. The brake member toothed structure 409 of the brake member 4 is driven to be meshed with the first middle disc toothed structure 309 of the middle disc 3 to prevent the middle disc 3 from rotating clockwise, which may prevent the elastic potential energy storage component from releasing elastic potential energy and play a role in fixing the clamping space. In addition, the clamping tongue 9 is mounted on the blade 6. When the blade 6 is contracted, the elastic tongue 913 on the blade 6 can preferably clamp the outer edge of the cup, thereby achieving a purpose of clamping the cup. An integral material of the clamping tongue 9 may be an elastic material such as silicone or rubber.

In a preferred implementation provided in the present disclosure, the first elastic member 8 may be three springs. In another optional implementation, the elastic structure may alternatively be another elastic component, for example, a component that can store elastic potential energy, such as an elastic rubber or a clockwork spring. A quantity of elastic structures may alternatively be set to one or more.

The present disclosure has the following beneficial effects. When the user uses different sizes of water cups, the expandable cup holder can clamp the cup by reducing the blades with small strength after the user puts the water cups in the cup holder. When the trigger switch is shifted, the elastic potential energy is released, and the clamping space of the blades is expanded, so that the cup can be easily taken out.

What is claimed is:

1. An expandable cup holder, comprising a cup holder body and a blade slidably connected to the cup holder body, wherein
the cup holder body comprises an upper disc, an elastic potential energy storage component, and a lower disc that are successively disposed;
the elastic potential energy storage component comprises a first elastic member and a second elastic member, the elastic potential energy storage component is elastically connected to the upper disc by using the first elastic member, the first elastic member is configured to store elastic potential energy, the elastic potential energy storage component is elastically connected to the upper disc by using the second elastic member, and the second elastic member is configured to prevent the elastic potential energy storage component from automatically releasing the elastic potential energy; and
the upper disc is fixedly connected to the lower disc.

2. The expandable cup holder according to claim 1, wherein the elastic potential energy storage assembly comprises at least one first elastic member, the upper disc is provided with at least one first upper disc fixed column, the elastic potential energy storage component comprises a middle disc, the middle disc is provided with at least one middle disc fixed column, and two ends of the first elastic member are respectively fixedly connected to the first upper disc fixed column and the middle disc fixed column.

3. The expandable cup holder according to claim 2, wherein the elastic potential energy storage component comprises a trigger switch, the trigger switch is provided with a support column, the upper disc is provided with a second upper disc fixed column, and two ends of the second elastic member are respectively fixedly connected to the support column and the second upper disc fixed column.

4. The expandable cup holder according to claim 3, wherein the elastic potential energy storage component comprises a brake member, the brake member is provided with a slotted hole, the upper disc is provided with an upper disc shaft column, and the brake member is connected to the upper disc shaft column by using the slotted hole.

5. The expandable cup holder according to claim 4, wherein the brake member is provided with a columnar body, the trigger switch is provided with a guide rail, and the brake member slides in the guide rail by using the columnar body to be slidably connected to the trigger switch.

6. The expandable cup holder according to claim 5, wherein the brake member is provided with a brake member toothed structure, the middle disc is provided with a first middle disc toothed structure, and the brake member toothed structure is in meshed connection with the first middle disc toothed structure.

7. The expandable cup holder according to claim 3, wherein an outer edge of the trigger switch is provided with at least one bulge structure.

8. The expandable cup holder according to claim 2, wherein the blade is provided with a sliding chute, the upper disc is provided with an upper disc sliding rail, and the blade is slidably connected to the upper disc sliding rail by using the sliding chute.

9. The expandable cup holder according to claim 8, wherein the cup holder body further comprises a gear, the upper disc is provided with a gear fixed column, and the gear is rotatably connected to the gear fixed column.

10. The expandable cup holder according to claim 9, wherein one surface that is of the blade and that deviates from the sliding chute is provided with a blade toothed structure, the blade comprises a blade middle slot, the blade middle slot passes through the gear fixed column, so that the blade toothed structure is meshed with the gear.

11. The expandable cup holder according to claim 10, wherein the middle disc is provided with a second middle disc toothed structure, and the second middle disc toothed structure is meshed with the gear.
